(19) United States
(12) Patent Application Publication
(10) Pub. No.: US 2006/0213981 A1
(43) Pub. Date: Sep. 28, 2006

(54) Portable information processing terminal apparatus

(75) Inventors: Hitoshi Suzuki, Tokyo (JP); Tsuyoshi Nagaeda, Tokyo (JP); Musashi Sato, Tokyo (JP); Shinichi Omori, Tokyo (JP)

Correspondence Address: Thomas Spinelli;Scully, Scott, Murphy & Presser, Suite 300, 400 Garden City Plaza, Garden City, NY, 11530, US

(73) Assignee: OLYMPUS MEDICAL SYSTEMS CORP., Tokyo (JP)

(21) Appl. No.: 11/388,618

(22) Filed: Mar. 24, 2006

(30) Foreign Application Priority Data
Mar. 24, 2005 (JP) 2005-087287

(51) Int. Cl. G06K 5/00; G06K 7/10

(52) U.S. Cl. 235/380; 235/472.02

(57) ABSTRACT

In a hospital information system, a PDA reads identification information attached to patients and medicines. A positional information acquiring unit acquires the information on the position of the PDA and restricts a function of an RF reader in accordance with the acquired positional information. The positional information acquiring unit may receive a position selection input from a user. The positional information acquiring unit may acquire the positional information on a present position, based on strength of signals from surrounding access points. A patient information acquiring unit may acquire profile information on patients to be attended, and the function restricting unit may restrict a function of the RF reader in response to the acquired profile information on patients.

### CROSS-REFERENCE TO RELATED APPLICATIONS

This application is based upon and claims the benefit of priority from the prior Japanese Patent Application No. 2005-87287, filed on Mar. 24, 2005, the entire contents of which are incorporated herein by reference.

### BACKGROUND OF THE INVENTION

1. Field of the Invention

The present invention relates to information processing terminal apparatuses, and it particularly relates to a portable information processing terminal apparatus which can read the identification information contained in the medical material supplies and attached to patients in the nursing sites.

2. Description of the Related Art

A system for managing medical treatment actions and especially nursing care actions is structured by a network of personal computers (hereinafter referred to as PCs), PDAs (personal digital assistants) and the like, which are connected with each other by a wired or a wireless LAN (Local Area Network). In a system as disclosed in Reference (1) in the following Related Art list, for example, nurses carry with them PDAs as information processing terminal apparatuses and perform their nursing care for patients by referring to a work schedule listing intravenous drips, injections and other care actions. Upon completion of a care action, the nurse who has performed it inputs the execution result to his/her PDA. The PDA, in turn, transmits the inputted execution result to a hospital information management system, which manages the performance details of nursing care actions. The PDA as disclosed in Reference (1) is equipped with means of non-contact reading of identification information from RF tags used.

Related Art List

(1) Japanese Patent Application Laid-Open No. 2004-348717.

According to the technology disclosed in Reference (1), errors in nursing care actions can be reduced because nurses themselves confirm the details of their care actions by operating their PDAs on the spot. In particular, the facility of non-contact reading of information contained in RF tags attached to medicines and the like improves the usability as well as operability of PDAS. On the other hand, however, care must be exercised to eliminate any adverse effects of radio waves on nearby medical equipment since radio communication is used in the reading of information from the RF tags.

### SUMMARY OF THE INVENTION

The present invention has been made in view of the foregoing circumstances and a general purpose thereof is to provide a technology for determining use or nonuse for the means of non-contact reading of information from RF tags or the like according to the surrounding conditions.

In order to solve the above problems, a portable information processing terminal apparatus according to one embodiment of the present invention includes: a tag-information reader which reads information from an RF tag; a positional information acquiring unit which acquires positional information on the portable information processing terminal apparatus; and a function restricting unit which restricts a function of the tag-information reader, in accordance with the acquired positional information. The function restricting unit may restrict part of the function of the tag-information reader or the entire functions.

Another embodiment of the present invention relates also to a portable information processing terminal apparatus. This information processing terminal apparatus includes: a tag-information reader which reads information from an RF tag; a patient information acquiring unit which acquires profile information on a patient to be attended; and a function restricting unit which restricts a function of the tag-information reader, in accordance with the acquired profile information on a patient. The function restricting unit may restrict part of the function of the tag-information reader or the entire functions.

Still another embodiment of the present invention relates also to a portable information processing terminal apparatus. This information processing terminal apparatus includes: an information reader, of non-contact type, which reads information; an information acquiring unit which acquires information on usage environment of the portable information processing terminal apparatus; and a function restricting unit which restricts a function of the information reader, in accordance with the acquired information on usage environment thereof. The function restricting unit may restrict part of the function of the information reader or the entire functions.

It is to be noted that arbitrary combinations of the aforementioned constituting elements and the implementations of the invention in the form of method, apparatus, system, computer program, data structure and so forth are effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates a structure of a hospital information system according to an embodiment of the present invention.

FIG. 2 illustrates a hardware structure of a PDA.

FIG. 3 is an external view showing an external structure of a PDA.

FIG. 4 illustrates a structure by which to execute a switching processing of information reading-means in a PDA according to an embodiment of the present invention.

FIGS. 5A to 5E illustrate examples of screen transition of an operation screen.

FIG. 6 is a flowchart showing a procedure for determining use or nonuse of an RF reader according to a selected hospital ward.

FIG. 7 illustrates an example of a reference table.

FIG. 8 is a flowchart showing a procedure for determining use or nonuse of an RF reader based on a present position of a PDA.

FIG. 9 is provided to explain an area where the use of RF reader is prohibited in a hospital ward.

FIG. 10 is a flowchart showing a procedure for determining use or nonuse of an RF reader according to a condition of a patient.

FIG. 11 illustrates a format of patient profile information.

### DETAILED DESCRIPTION OF THE INVENTION

The invention will now be described by reference to the preferred embodiments. This does not intend to limit the scope of the present invention, but to exemplify the invention.

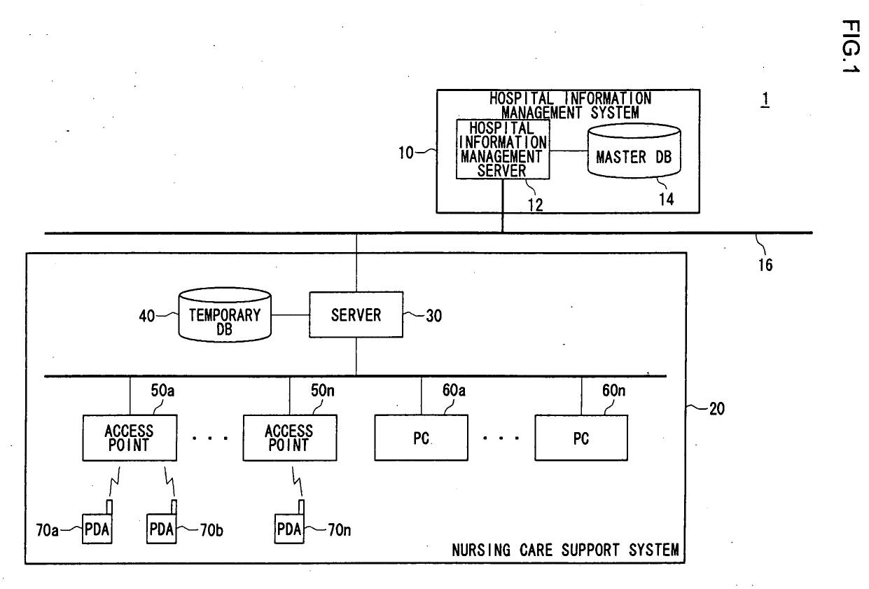

FIG. 1 illustrates a structure of a hospital information system 1 according to an embodiment of the present invention. The hospital information system 1, which is to be installed in a hospital or other medical facility, is comprised of a hospital information management system 10 as a main system thereof and a nursing care support system 20 as a sub-system thereof. The hospital information management system 10 and the nursing care support system 20 are connected with each other via a LAN (Local Area Network) 16 in such a manner as to enable communication therebetween. Although not shown in FIG. 1, other sub-systems within a medical facility, such as an anesthesia support system for managing the procedure for anesthesia or a rehabilitation support system for managing rehabilitation programs, may be connected to the LAN 16. The hospital information management system 10 has a function of managing in a centralized and integrated manner the sub-systems, such as a nursing care support system 20, which are connected thereto via the LAN 16.

The hospital information management system 10 includes a hospital information management server 12 that manages and controls the operation of a nursing care support system 20 and other sub-systems and a master DB 14 that records data and the like acquired by the nursing care support system 20 and other sub-systems. The master DB 14 is designed to record authentic data only and is provided with an advanced security measure to prevent any alteration of data from outside sources.

The nursing care support system 20 includes a server 30 which executes a nursing care support function, a temporary DB 40 which records desired data, PDAs 70a to 70n (hereinafter represented as and referred to as “PDA 70”) which are mobile terminals carried by medical staff members such as nurses, access points 50a to 50n (hereinafter represented as and referred to as “access point 50”) which receive and transmit data to and from the PDA 70 through a wireless LAN constructed among the PDAs 70a to 70n, and personal computers 60a to 60n (hereinafter represented as and referred to as “PC 60”) for inputting and outputting the data. The PCs 60 are stationary terminals. And the medical staff members input, refer to, confirm the data and do other necessary processes at places where the PC is installed.

The PDA 70 includes the usual functions such as an input unit for inputting data by a touch panel or the like, a processing unit (CPU or the like) for processing the inputted data, a storage unit for holding data, and a display unit for displaying the processed data or the like). In addition to these functions, the PDA 70 includes, as built-in functions, a wireless LAN card which can communicate wirelessly with the access points 50 via the wireless LAN and a reading unit for reading identification information attached to patients, the medicine bottles and the like.

As a reading unit for reading identification information, the PDA 70 is provided with an optical reader which can read optically two- or three-dimensional identification codes and an RF reader which reads identification information from an RF (Radio Frequency) tag through radio waves or electromagnetic waves. Since the reading of identification information can be done accordingly, the medical personnel such as nurses carrying the PDA 70 can input (therefore read in) the identification information, such as user IDS serving as identification codes for identifying medical staffs themselves, patient IDs for identifying patients to whom the nursing care action to be carried out and injection IDs, in an accurate, simple and prompt manner. The PDA 70 is easy to use in the wards, which has a waterproof structure resistant to medical solution.

As already described above, the PDA 70 has a communication function by a wireless LAN and therefore the PDA 70 is structured such that, within an accessible range from the access point 40, the hospital information management system 10 is accessed from any given location via the server 30, then the work schedules data containing work descriptions are acquired and the acquired work schedule data are displayed on the PDA 70.

A nursing care support system 20 is, for instance, incorporated into such systems as an outpatient system and a hospital ward system, which may involve entries and registration of work schedule data for injections and other treatments, a pharmacy system, which may dispense medicines based on the entries of work schedule data for injections and other treatments, a medical affairs system, which may perform the accounting and the like for medical treatment actions, and a nurse (station) system, which may cover mixed injections and the like by nurses. The access points 50 and the PCs 60 are to be placed in a large number especially in nurse systems and ward systems, in which nurses perform nursing cares, and the PDAs 70 carried by all the nurses allow them to make inputs and outputs concerning nursing care actions on the spot, which may most likely be the bedside of inpatients.

As described above, the hospital information system 1 according to the present embodiment is so structured as to be able to record or refer to the status of nursing care action in real time. When performing a nursing care action, a nurse carrying a PDA 70 with him/her can confirm the contents of a work schedule for the nursing action and can perform the scheduled nursing care actions after having confirmed the contents of the work schedule. As a result, the scheduled nursing care actions to be conducted can be performed with accuracy and with the least error. After having conducted a nursing care action, the contents of a nursing care action done can be easily inputted to the PDA on the spot where it was conducted. Thus, the contents of nursing care actions conducted can be recorded with accuracy and with the least error.

When conducting a nursing care action, the nurse carrying the PDA 70 can refer to and confirm with the PDA 70 at an arbitrary place and at arbitrary time, utilizing the PDA 70 he/she carries with him/her. This allows the nurses to conduct the nursing care actions in a quick and efficient manner. Even in a case when a scheduled work description was changed at the last minute, said scheduled work description which has been changed can be confirmed on the spot, where the care action is to take place, just before conducting the care action. Hence, the change in the scheduled work description, if any, can be easily dealt with.

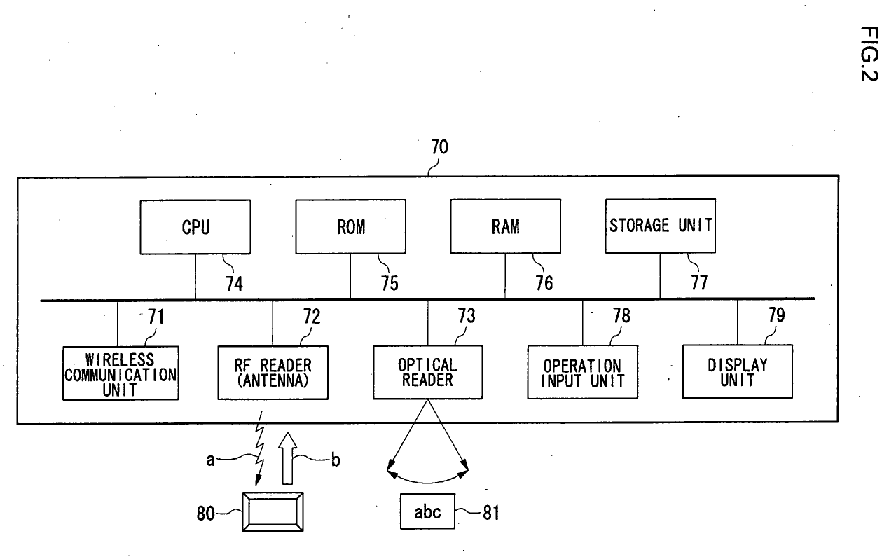

FIG. 2 illustrates a hardware structure of a PDA 70. The PDA 70 includes a wireless communication unit 71, an RF reader 72, an optical reader 73, a CPU 74, a ROM 75, a RAM 76, a storage unit 77, an operation input unit 78 and a display unit 79, all of which are mutually connected via a bus. The wireless communication unit 71 achieves a radio communication function of the PDA 70, and it transmits and receives data, such as characters and images, to and from a server 30 by a radio communication via an access point provided in every part of hospital.

The RF reader 72 and the optical reader 73 constitutes a reading unit for reading the identification information attached to patients and medicines. In the hospital information system 1 according to an embodiment, an RF tag 80 recording the identification information of a patient in memory and an identification code 81 recording the identification information of the patient are also attached to a wristband which is worn around the patient's wrist to identify the patient. An RF tag 80 recording the identification information of medicine and an identification code 81 recording the identification information of the medicine are also attached to a medicine bottle to identify the medicine, for example. According to the present embodiment, the PDA 70 reads the identification information from the RF tag 80 or identification code 81, so that the patients or medicines can be identified quickly and reliably. The RF tag 80 and the identification code 81 which are attached to a single object have both recorded the same identification information. If neither the RF tag 80 nor the identification code 81 cannot be used, it is then possible for a user to input manually the identification information to the PDA 70.

The RF reader 72, which is a non-contact type information reading unit, can wirelessly communicate with the RF tag 80 within a range of some centimeters to some meters depending on the strength of radio waves which can be set arbitrarily. The RF reader 72 can read and write data from memory in the RF tag 80 and to the same memory, with the RF tag 80, through the non-contact communication. It is to be noted that according to the present embodiment the RF reader 72 is mainly used for the readout of identification information from the memory in the RF tag 80.

The RF tag 80 is constituted by a flexible chip of as small as 4 mm square or so, and it is protected by a thin film resin. Though not shown specifically, the RF tag 80 is comprised of a CPU, a memory, an antenna, a voltaic circuit and so forth. A voltaic circuit is given an electromotive force in response to a predetermined radio wave a of radiofrequency from the RF reader 72, and the electromotive force operates on the CPU so as to send data b in the memory of the RF tag 80 to the RF reader 72. Note that a built-in battery may be provided in the RF tag 80.

The optical reader 73, which is a non-contact type optical information reading unit, can optically read the identification code 81. For example, the optical reader 73 may be structured as an OCR (Optical Character Reader). The optical reader 73 scans an identification code 81 optically and reads the identification code 81 by detecting the reflected light.

A CPU (Central Processing Unit) 74 is a central processing unit that controls the operations of the PDA 70 as a whole. A ROM (Read Only Memory) 75 is a memory that stores basic control programs executed by the CPU 74. The CPU 74 executes the basic control programs at the start-up of the PDA 70, so that the basic control of entire operation of the PDA 70 is performed by the CPU 74.

A RAM (Random Access Memory) 76 is used as a working memory when the CPU 74 executes various types of application programs stored in the storage unit 77, and is also used as a main memory which is used, as necessary, as a temporary storage area for various types of data. The storage unit 77 is a memory that stores and holds a great variety of application programs. A semiconductor memory such as an EEPROM (Electrically Erasable and Programmable Read Only Memory) is suitable as the storage unit 77. The EEPROM is particularly suitable in that it not only can rewrite the memory content electrically but also requires no power supply for the storage of the memory content.

The operation input unit 78 is, for example, a touch panel provided on the display unit 79, or operation buttons provided externally to the display unit 79 which can be operated by the user of the PDA 70. The operation input unit 78 detects an operation which was actually inputted and effected and sends it to the CPU 74. For example, although the identification information attached to patients and medicines are read basically by use of the RF reader 72 or optical reader 73, the user types in the identification information by operating on the touch panel provided on the display unit 79 in the case when both the RF reader 72 and the optical reader 73 cannot be used. The display unit 79 may be a liquid crystal display, for example, and displays various types of information sent from the CPU 74 so as to provide various types of information to the user.

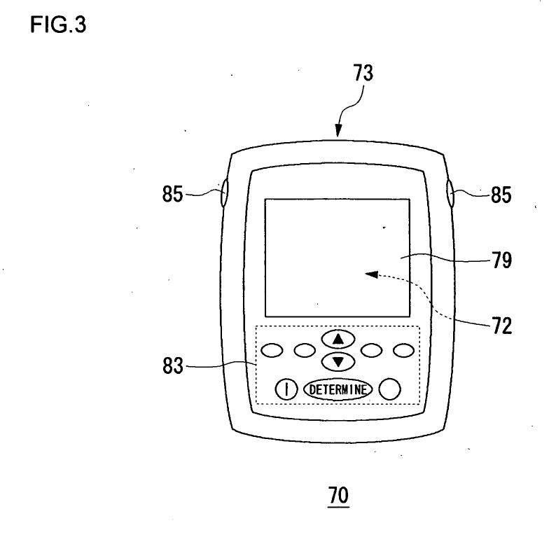

FIG. 3 is an external view showing an external structure of a PDA. The PDA 70 is designed to have such a form as to be held by one hand, and it includes a display unit 79, which is provided in front, made of LCD (Liquid Crystal Display). As described above, the display unit 79 is provided with a touch panel, so that user can enter a desired input by operating on the touch panel. Provided below the display unit 79 is a group of operation buttons 83 comprised of a plurality of operation buttons.

The PDA 70 has an optical reader 73 provided at the front edge thereof. The PDA 70 also has an RF reader 72 provided on the back side thereof. The RF reader 72 and the optical reader 73, which are set in a usable state selectively, read identification information attached to a patient or medicine when turned on. It is to be noted here that only one of the RF reader 72 and the optical reader 73 is to be set in a usable state at one time and both of them are not used together at the same time.

The user can turn on the RF reader 72 or the optical reader 73, which is set in a usable state, by pressing a scan button 85. When the RF reader 72 is in a usable state, the user brings the back side of the PDA 70 close to an RF tag 80 and presses the scan button 85, and the RF reader 72 will turn on and read information from the RF tag 80. When the optical reader 73 is in a usable state, the user brings the front edge of the PDA 70 close to an identification code 81 and changes the orientation of the PDA 70 while pressing the scan button 85 in such a way that the emitted light scans the whole surface of the identification code 81 to read information therefrom. Note that the reading direction in which the RF reader 72 reads information may be set on the front edge of a PDF 70 instead of the back side thereof.

The RF reader 72 and the optical reader 73 are both excellent non-contact information reading unit. Comparatively speaking, however, the optical reader 73, which reads the code information of an identification code 81 optically, must be brought closer to the identification code 81 than for the RF reader 72 to an RD tag 80. When an identification code 81 given to a wristband worn around the wrist of a patient is to be read, for instance, it is preferable that the identification code 81 is not bent. Thus, depending on the posture of the patient, there may be cases where it is difficult to use the optical reader 73. On the other hand, the RF reader 72, which uses wireless communication, can read information of an RF tag 80 from a certain distance away, so that the reading accuracy thereof is less affected by the posture of the patient. Hence, the PDA 70 according to the present embodiment makes the RF reader 72 usable under normal circumstances, thus accomplishing an easy information reading.

The reading of information from an RF tag 80 by the RF reader 72, however, generates radio waves, and therefore the RF reader 72 should not be used, for instance, in an operating room or intensive-care unit (ICU), where there is an array of medical equipment, so as not cause any adverse effects on the medical equipment. Also, the RF reader 72 should not be used for certain kinds of patients, such as one with a pacemaker implanted in the body. Since the PDA 70 according to the present embodiment is equipped with an optical reader 73 also, the optical reader 73, which does not affect the operation of medical equipment, can be used where the use of the RF reader 72 is not desirable. The arrangement may also be such that the user assesses the environment for use or the condition of a patient and manually switches the information reading unit from the RF reader 72 to the optical reader 73 as appropriate. However, leaving the decision on the switching to the user will place a burden on the user and besides a busy user may forget about the switching. Thus, the PDA according to the present embodiment has a function of autonomously switching the information reading unit, thereby realizing a safe information reading processing.

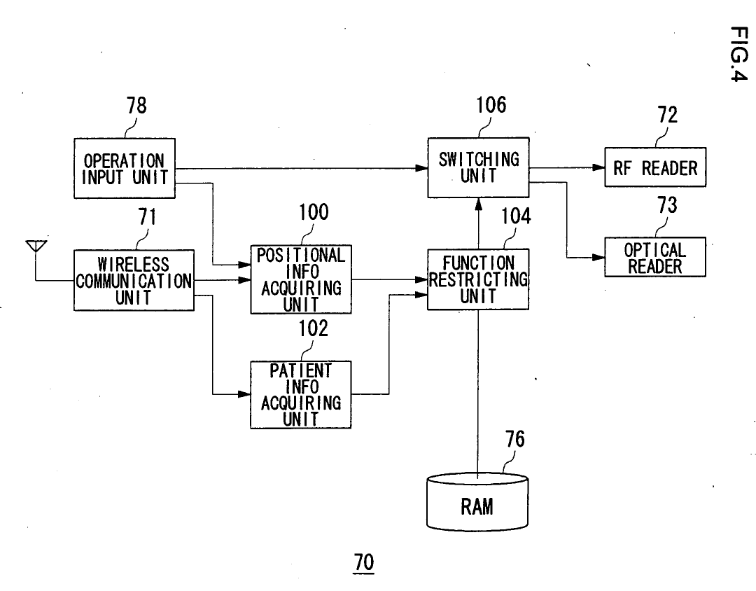

FIG. 4 illustrates a structure by which to execute a switching processing of information reading unit in a PDA according to the embodiment. FIG. 4 is a block diagram showing a software-like structure realized by the CPU 74 and the RAM 76, in addition to the hardware structure shown in FIG. 2. More specifically, the PDA 70 further includes functions of a positional information acquiring unit 100, a patient information acquiring unit 102, a function restricting unit 104 and a switching unit 106, and it executes a switching processing of the information reading unit.

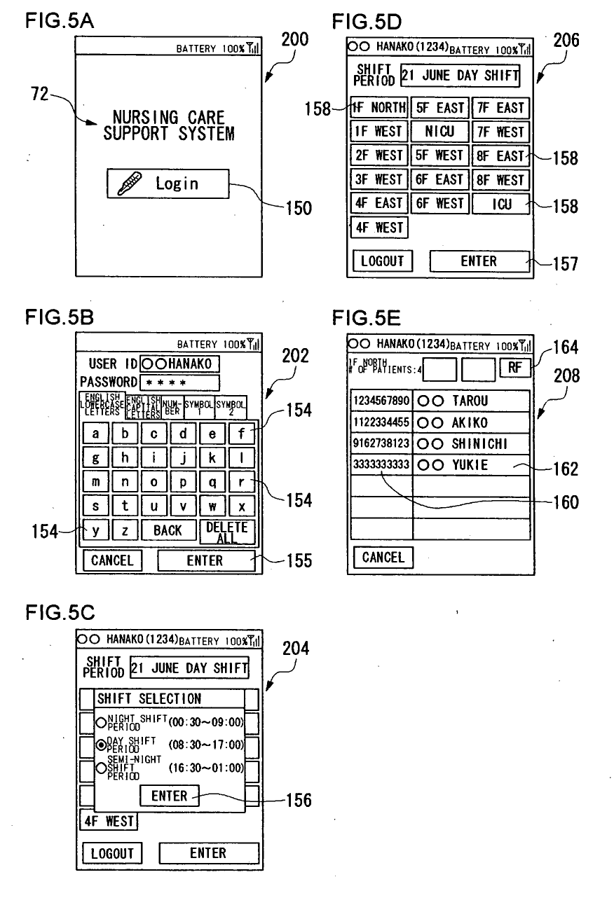

Firstly, a description will be given of an example of deciding use or nonuse of the RF reader 72 based on the position where the PDA 70 is used in a medical facility. A nurse, or user, checks on the detail of nursing care expected by looking at the control screen displayed on the display 79 of the PDA 70. FIG. 5 illustrates transitions in display on the control screen.

FIG. 5A is a start-up screen 200 displayed immediately after the power-on of the PDA 70. A login icon 150 of the PDA 70 is displayed on the display unit 79 comprised of a touch panel.

When the user selects the login icon 150, a login screen 202 as shown in FIG. 5 is displayed on the display unit 79. The user enters a user ID and a password on the display unit 79, using input keys 154. When a confirm key 155 (shown as ENTER in FIG. 5B) is depressed, the user ID and password which have been inputted are sent from the wireless communication unit 71 to the access point 50, so as to be sent to the nursing care support system 20. The nursing care support system 20 authenticates the user having the user ID and password.

Upon a successful authentication of the user, the display 79 switches its display to a shift selection screen 204 as shown in FIG. 5C. The screen displays the name of the user who has logged in and the code assigned to him/her at the top thereof and a shift selection screen in the middle thereof. The work shift periods are, for example, night shift (0:30-9:00), day shift (8:30-17:00) and semi-night shift (16:30-01:00), but the setting of time periods is changeable. According to the present embodiment, the shift period including the time of log-in by the user is displayed in the middle as a default selection state, and the other two shift periods before and after it. The user can obtain work schedule data for the selected shift period by selecting the shift and depressing a confirm key 156 (shown as ENTER in FIG. 5C). Note that the overlapping parts of the shift periods are provided in consideration of the transfer of work and the like.

With a shift period selected, a ward listing screen 206, as illustrated in FIG. 5D, is displayed. Now the user selects a select key 158 for a hospital ward where the nursing care is expected and press an confirm key 157 (shown as ENTER in FIG. 5D), then the PDA 70 will transmit the logged-in user information, the shift period, the ward information and the like to a server 30. Upon receipt of the transmission from the PDA 70, the server 30 accesses the hospital information management system 10 to search and acquire therefrom the information on a patient or patients to be attended in the selected ward during the selected shift period.

The patient information thus acquired is transmitted from the server 30 to the PDA 70, and a patient listing screen 208, as illustrated in FIG. 5E, is displayed on the display 79 of the PDA 70. In the example of FIG. 5E, the “1FN” ward has been selected, and there are four patients in the “1FN” ward who are to be attended by the user. The patient listing screen 208 displays the patient IDs 160 having been given to the respective patients and the patient names 162, for instance.

According to the present embodiment, if ward information is specified on the ward listing screen 206 of FIG. 5D, then an identification information reading unit that can be used in the ward will be indicated in the display area of an input mode switch key 164 on the patient listing screen 208 of FIG. 5E. As already mentioned, if the RF reader 72 is usable, the RF reader 72 will be selected preferentially as the usable identification information reading unit. On the other hand, if the RF reader 72 is not usable, the optical reader 73 will be selected instead as the usable identification information reading unit. On the patient listing screen 208 shown in FIG. 5E, the “RF” displayed at an input mode switch key 164 is indicating that the RF reader 72 is usable at the moment. It is to be noted here that depressing the input mode switch key 164 will switch the usable identification information reading unit and set the optical reader 73 in a usable state. At this time, the input mode switch key 164 displays “OPT” (optical). In this manner, the input mode switch key 164 has a function of not only displaying a currently usable identification information reading unit but also switching the identification information reading unit when depressed.

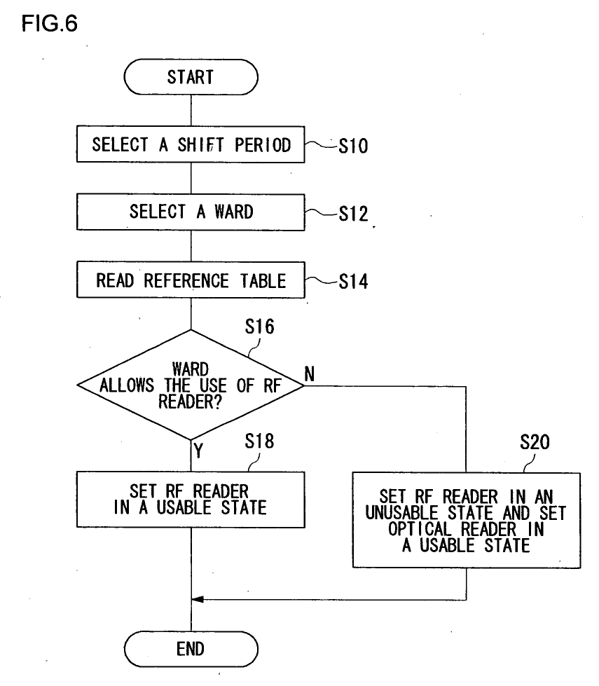

FIG. 6 is a flowchart showing a procedure for determining use or nonuse of an RF reader according to a hospital ward selected. Referring to FIG. 4, the user selects a shift period by operating on the touch-panel operation input unit 78 (S10), and then selects a hospital ward (S12). The selection of a shift period and a hospital ward is carried out from an operation screen shown in FIGS. 5C and 5D. When a hospital ward is selected by the operation input unit 78, information on the ward selected is sent to the positional information acquiring unit 100. Thereby, the positional information acquiring unit 100 acquires positional information of the PDA 70 used, namely, positional information of the ward used. The positional information acquiring unit 100 sends the acquired ward information to the function restricting unit 104.

The storage unit 77 has a reference table correlating the positional information of facilities inside a hospital where the PDA 70 is used with the usability information of the RF reader 72. The RAM 76 reads the reference table from the storage unit 77 and supplies it to the function restricting unit 104.

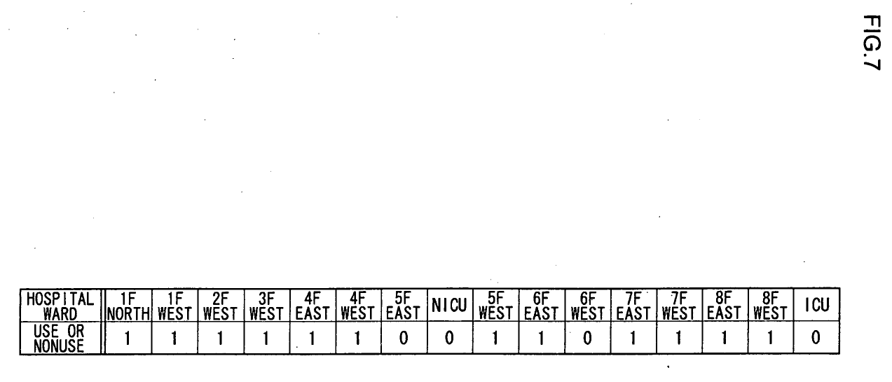

FIG. 7 illustrates an example of a reference table. In the reference table, the usability information of the RF reader 72 is given in correspondence to the wards within a hospital. The usability information is set as flags, and bit value “1” denotes usable and bit value “0” unusable. As shown in the table, bit value “0” is assigned to four hospital wards, namely, the “5F EAST” ward, the “NICU” ward, the “6F WEST” ward and the “ICU” ward. Accordingly, when any of these four wards is selected as a ward where the PDA 70 is to be used, the function of the RF reader 72 is restricted.

The function restricting unit 104 refers to the reference table as shown in FIG. 7 and restricts the function of the RF reader 72 according to the positional information acquired by the positional information acquiring unit 100, or in this case according to the ward information selectively inputted by the user. To be more precise, the function restricting unit 104 restricts the function of the RF reader 72 when the bit value of the usability information correlated to the acquired ward information in the reference table is “0”. The use of the reference table makes it possible to accurately manage the use of the RF reader 72 in relation to the respective wards.

According to the present embodiment, the function of the RF reader 72 is restricted by restricting all the functions of the RF reader 72, that is, by making the RF reader 72 unusable. Also, as a less strict functional restriction, a communicable distance to an RF tag 80 may be shortened, for instance, by reducing the strength of radio waves generated by the RF reader 72. Such an arrangement can reduce the adverse effects of radio waves on nearby equipment.

Thus, when the selected ward is a ward which does not allow the use of the RF reader 72 (N of S16), the function restricting unit 104 sets the RF reader 72 in an unusable state and the optical reader 73 in a usable state (S20). The function restricting unit 104 sends an instruction of this state setting to the switching unit 106. Upon receipt of this state setting instruction, the switching unit 106 sets the display of the input mode switch key 164 of FIG. 5E to “OPT” (optical) and prohibits the use of the RF reader 72. On the other hand, when the selected ward is a ward which allows the use of the RF reader 72 (Y of S16), the function restricting unit 104 sets the RF reader 72 in a usable state (S18). The function restricting unit 104 sends an instruction of this state setting to the switching unit 106. Upon receipt of this state setting instruction, the switching unit 106 sets the display of the input mode switch key 164 of FIG. 5E to “RF”.

The user can switch the identification information reading unit by depressing the input mode switch key 164 of FIG. 5E. In response to the depression of the input mode switch key 164, the switching unit 106 switches the usable identification information reading unit from the RF reader 72 to the optical reader 73 or from the optical reader 73 to the RF reader 72.

When the user has depressed the input mode switch key 164, the switching unit 106 performs a switching processing of identification information reading unit according to the state setting instruction sent from the function restricting unit 104. When the RF reader 72 has been set in an unusable state by the function restricting unit 104, the switching unit 106 is setting the optical reader 73 in a usable state. In this state, even if the input mode switch key 164 is depressed by the user, the switching unit 106 does not switch the RF reader 72 to a usable state. Until the functional restriction of the RF reader 72 is canceled by the function restricting unit 104, the RF reader 72 remains set in an unusable state, and in response thereto, the switching unit 106 does not set the RF reader 72 in a usable state. In this manner, a switching instruction from the user is ignored when necessary, thus realizing a safe operation of the PDA 70 while avoiding any adverse effects of the RF reader 72 on nearby medical equipment.

As shown in the flowchart of FIG. 6, the PDA 70 according to the present embodiment has the usability of the RF reader 72 thereof determined in relation to the ward in which it is used. Nevertheless, when the user carrying the PDA 70 moves from a ward selected on the ward listing screen 206 of FIG. 5D to another ward or when he/she enters a room with specific medical equipment, it is preferable that his/her current position be detected in real time and the usability of the RF reader 72 be determined at the current position.

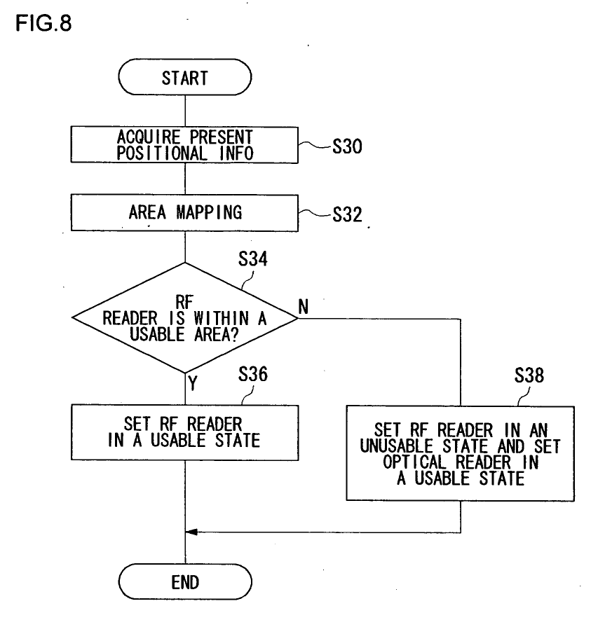

FIG. 8 is a flowchart showing the procedure for determining the usability (namely, use or nonuse) of an RF reader based on the current position of the PDA. Referring to FIG. 4, the wireless communication unit 71 detects the strength of signal from an access point 50 disposed in the neighborhood. When signals from a plurality of access points 50 are being received, the strengths of signals, for instance, from three access points 50 are detected in the descending order of signal strength. The signal strengths from the three access points 50 are then associated with the identification information of the access points 50 before they are sent to the positional information acquiring unit 100. When all the access points 50 are making transmissions with the same radio wave strength, the positional information acquiring unit 100 calculates the current position of the PDA 70 from the relative values of the three signal strengths. Note that the technique for measuring a current position from three or more transmission sources is a known technique like the one used in a GPS. In this manner, the positional information acquiring unit 100 acquires the positional information of a current position (S30). The positional information thus acquired is sent to the function restricting unit 104.

The RAM 76 has a map which sets nonuse areas for the RF reader 72 within hospital wards. For example, when medical equipment is temporarily installed in a certain room in the ward, the installation information is managed by the hospital information management system 10. And if the installed medical equipment is such as is likely to be adversely affected by the radio waves from the RF reader 72, the hospital information management server 12 will generate a map that sets the room as a nonuse area for the RF reader 72. The PDA 70 receives this map from the wireless communication unit 71 and stores it in the RAM 76.

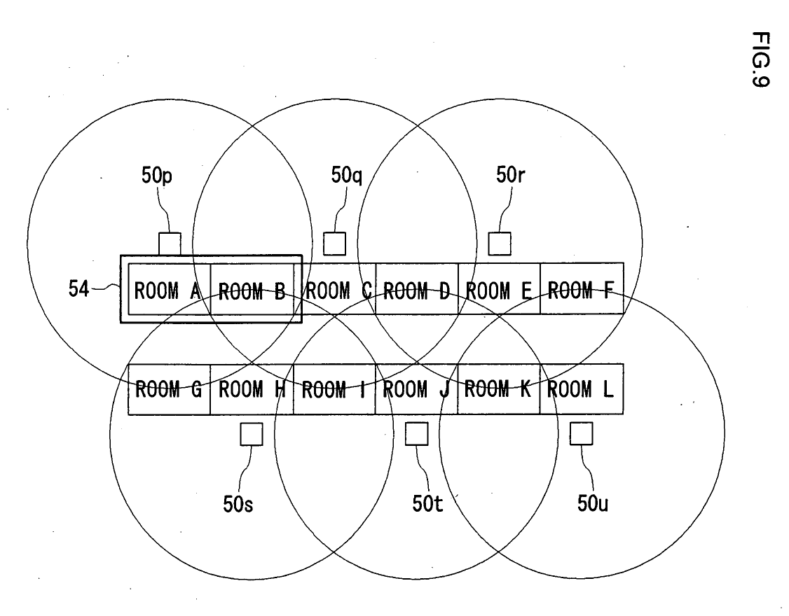

FIG. 9 is provided to explain an area where the use of RF reader 72 is prohibited in a hospital ward. Twelve rooms, which are room A to room L, are arranged in this hospital ward, and the room A and the room B are set as a nonuse area 54. This indicates that the use of RF reader 72 is prohibited in the room A and the room B in this ward. Total of six access points, which are access points 50p, 50q, 50r, 50s, 50t and 50u, are set up in this ward. The unusable area 54 and the usable area are generated, as a map, by the hospital information management server 12.

The function restricting unit 104 reads the map from the RAM 76 and compares the current position information sent from the positional information acquiring unit 100 against the map (S32). When the current position of the PDA 70 is within a nonuse area 54 (N of S34), the function restricting unit 104 restricts the function of the RF reader 72. In the present embodiment, the function of the RF reader 72 is restricted by setting the RF reader 72 in an unusable state (S38). As a less strict functional restriction, a communicable distance to an RF tag 80 may be shortened, for instance, by reducing the strength of radio waves generated by the RF reader 72. Such an arrangement can reduce the adverse effects of radio waves on nearby equipment. At this time, in the place of the RF reader 72, the optical reader 73 is set in a usable state.

On the other hand, when the current position of the PDA 70 is outside a nonuse area 54 where the use is prohibited (Y of S34), the function restricting unit 104 sets the RF reader 72 in a usable state (S36). Note, however, that when the PDA 70 is in a ward where it cannot be used as shown in the flowchart of FIG. 6, the RF reader 72 is kept in an unusable state. Therefore, a determination processing as shown in FIG. 8 may be carried out when the PDA 70 is in a ward where the RF reader 72 is usable. This determination processing as shown in FIG. 8, which is performed based on the current position information, excels in real-time determination. Hence, the determination of the usability of the RF reader 72 may be realized efficiently according to the circumstances by periodically carrying out the determination processing as shown in FIG. 8 after carrying out the determination processing as shown in FIG. 6 at the time of log-in. It is also possible that the determination processing as shown in FIG. 6 is skipped and the determination processing as shown in FIG. 8 is carried out independently.

Next, a description will be given of a method for determining the usability of the RF reader 72 according to the condition of a patient. The determination processing according to the condition of a patient may be carried out in conjunction with the above-mentioned determination processing according to positional information or independently.

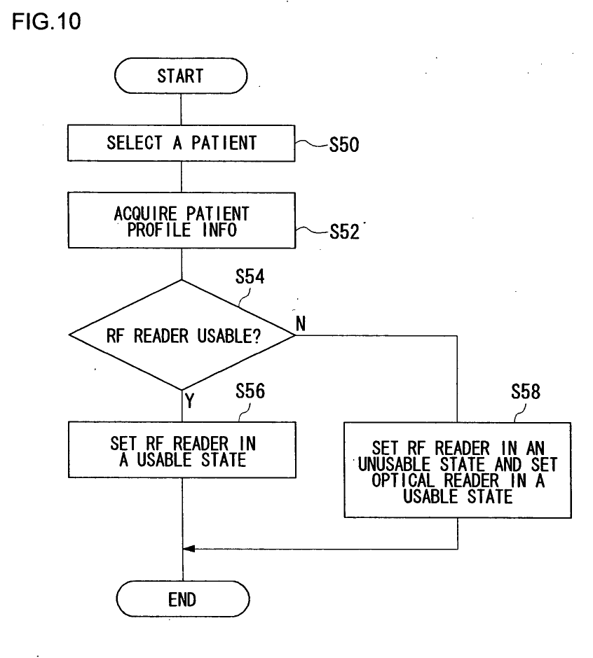

FIG. 10 is a flowchart showing the procedure for determining the usability of the RF reader according to the condition of a patient. Referring back to FIG. 4, the user selects a patient or patients from the control input unit 78 by consulting the patient listing screen 208 as shown in FIG. 5E (S50). The information on the selected patient or patents is transmitted from the wireless communication unit 71 to the hospital information management system 10 via an access point 50. The hospital information management server 12 retrieves the work schedule data set for the patient or patients from the master DB 14 and transmits it to the PDA 70 via the server 30.

At this time, the hospital information management server 12 also transmits the profile information of the patient or patients together with the order thereof to the PDA 70. The patient profile information includes a description of the physical features of the patients.

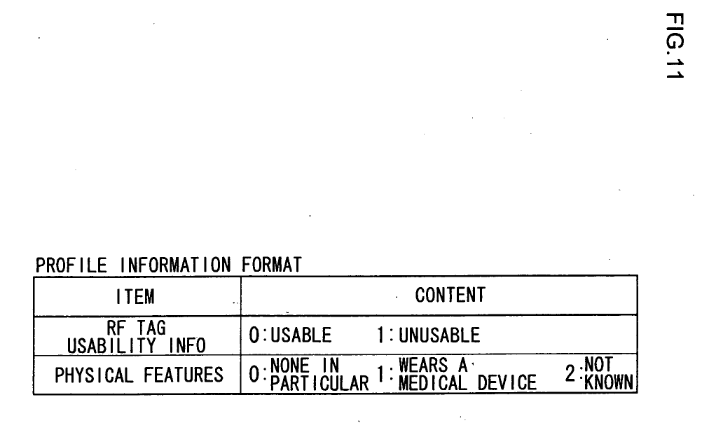

FIG. 11 shows a format of patient profile information. Set in the patient profile information are two items which are RF tag usability information and physical features.

“RF tag usability information” is the flags setting “usable” and “unusable” of the RF reader 72. Whereas the value “0” indicates that the use of the RF reader 72 is permitted thus “usable”, the value “1” indicates that the use of the RF reader 72 is not permitted thus “not usable”.

“Physical features” indicate the physical features of a patient. The value “0” indicates that the patient has normal physical features, the value “1” that the patient wears a medical device such as a pacemaker, and the value “2” that the physical features of the patient, such as the wearing of a medical device, are not known because of an emergency case for instance. For example, the value “2” is assigned to an emergency case when a patient is brought in unconscious.

When the wireless communication unit 71 receives the work schedule data and the patient profile information, the patient information acquiring unit 102 acquires the patient profile information (S52). The patient information acquiring unit 102 conveys the patient profile information to the function restricting unit 104. The function restricting unit 104 refers to the patient profile information and when the value of “RF tag usability information” is “0” and the value of “physical features” is “0”, it is determined that the RF reader 72 can be used (Y of S54). With this determination, the function restricting unit 104 sets the RF reader 72 in a usable state (S56) and sends to the switching unit 106 an instruction to set this state.

On the other hand, the function restricting unit 104 refers to the patient profile information and when the value of “RF tag usability information” is “1” and the value of “physical features” is “1” or “2”, it is determined that the RF reader 72 is unusable (N of S54). With this determination, the function restricting unit 104 sets the RF reader 72 in an unusable state (S58). The function restricting unit 104 sends to the switching unit 106 an instruction to set this state. Upon receipt of this instruction to set this state, the switching unit 106 sets the display of the input mode switch key 164 to “OPT” (optical) and prohibits the use of the RF reader 72.

The present invention has been described based on the embodiments. These embodiments are merely exemplary, and it is understood by those skilled in the art that various modifications to the combination of each component and process thereof are possible and such modifications are also within the scope of the present invention.

As already mentioned, the determination of the usability of the RF reader 72 may be realized efficiently according to the circumstances by periodically carrying out the determination processing as shown in FIG. 8 after carrying out the determination processing as shown in FIG. 6 at the time of log-in. However, this can also be carried out jointly with the determination processing using the patient profile information as shown in FIG. 10. A use environment for the RF reader 72 in full consideration of safety can be realized by adding the condition of the patients to the determination of the usability of the RF reader 72 based on the positional information of the PDA 70.

A high degree of safety in the use of the RF reader 72 can be achieved by combining the three types of determination processing as shown in FIG. 6, FIG. 8 and FIG. 10. Yet, a combination of any two of the three types of determination processing can realize a use environment for the RF reader 72 in consideration of safety in a hospital. For example, a combination of the determination processing of FIG. 6 and that of FIG. 10 may help avoid the use of the RF reader 72 for a patient with a pacemaker implanted in the body even if the ward he/she is in is where the RF reader 72 is usable or may help avoid the use of the RF reader 72 for a normal patient to be attended in a ward where the use of the RF reader 72 is not considered appropriate.

A combination of the determination processing of FIG. 8 and that of FIG. 10 may help avoid the use of the RF reader 72 for a patient with a pacemaker implanted in the body even if the area he/she is in is where the RF reader 72 is usable or may help avoid the use of the RF reader 72 for a normal patient to be attended in an area where the use of the RF reader 72 is not considered appropriate.

In the present embodiments, the determination processing of the usability of the RF reader 72 has been described, but the determination processing of usability may also be carried out for the optical reader 73. The optical reader 73, which reads an identification code 81 optically, generates laser light or the like. Accordingly, the use thereof during the night when the patient is sleeping is not desirable. Therefore, the function restricting unit 104 may restrict the function of the optical reader 73 during the sleep hours, for instance. In this respect, if the patient has some eye problem for instance, such information may be stated in the physical features of the patient profile information and the use of the optical reader 73 may be restricted for the patient. Thus, the RF reader 72 and the optical reader 73 have their respective peculiarities in the reading of information, so that the handy use of the PDA 70 can be further improved by selectively using them to their best advantage.

While the preferred embodiments of the present invention have been described using specific terms, such description is for illustrative purposes only, and it is to be understood that changes and variations may be made without departing from the spirit or scope of the appended claims.

What is claimed is:

1. A portable information processing terminal apparatus, including:
a tag-information reader which reads information from an RF tag;
a positional information acquiring unit which acquires positional information on the portable information processing terminal apparatus; and
a function restricting unit which restricts a function of the tag-information reader, in accordance with the acquired positional information.

2. The portable information processing terminal apparatus according to claim 1, wherein the positional information acquiring unit receives a position selection input from a user.

3. The portable information processing terminal apparatus according to claim 1, wherein the positional information acquiring unit acquires information on a present position, based on strength of a signal from a surrounding access point.

4. The portable information processing terminal apparatus according to claim 1, wherein the function restricting unit disables the tag-information reader by referring to a table that associates information indicating whether said tag-information reader is enabled or not with positional information in a facility where the portable information processing terminal apparatus is used.

5. The portable information processing terminal apparatus according to claim 1 further including:
an identification code reader which reads an identification code; and
a switching unit which selects either the tag-information reader or the identification code reader and enables the selected reader,
wherein when the function restricting unit restricts a function of the tag-information reader, the switching unit enables the identification code reader.

6. The portable information processing terminal apparatus according to claim 5, wherein when the function restricting unit restricts a function of the tag-information reader, the switching unit keeps disabling the tag-information reader until the function restricting unit cancels the restriction on the function of the tag-information reader.

7. A portable information processing terminal apparatus, including:
a tag-information reader which reads information from an RF tag;
a patient information acquiring unit which acquires profile information on a patient to be attended; and
a function restricting unit which restricts a function of the tag-information reader, in accordance with the acquired profile information on a patience.

8. The portable information processing terminal apparatus according to claim 7 further including:
an identification code reader which reads an identification code; and
a switching unit which selects either the tag-information reader or the identification code reader and enables the selected reader,
wherein when the function restricting unit restricts a function of the tag-information reader, the switching unit enables the identification code reader.

9. The portable information processing terminal apparatus according to claim 8, wherein when the function restricting unit restricts a function of the tag-information reader, the switching unit keeps disabling the tag-information reader until the function restricting unit cancels the restriction on the function of the tag-information reader.

10. A portable information processing terminal apparatus, including:
information reader, of non-contact type, which reads information;
an information acquiring unit which acquires information on usage environment of the portable information processing terminal apparatus; and
a function restricting unit which restricts a function of the information reader, in accordance with the acquired information on usage environment thereof.
